(19) United States
(12) Patent Application Publication
(10) Pub. No.: US 2009/0313259 A1
(43) Pub. Date: Dec. 17, 2009

(54) CONTAINER HANDLERS FOR SHARING AND UNSHARING

(75) Inventors: Relja B. Ivanovic, Seattle, WA (US); Kenneth M. Tubbs, Issaquah, WA (US); Lindsey Noll, Seattle, WA (US); Chris J. Guzak, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/140,276

(22) Filed: Jun. 17, 2008

(51) Int. Cl. G06F 17/30

(52) U.S. Cl. 707/10; 707/200; 707/E17.032

(57) ABSTRACT

A container reference such as a library may reference other items and may be shared or unshared among computing devices, computing applications, or users. A sharing handler may be registered for the container reference and may be used in conjunction with the sharing and unsharing of the container reference and the items that are referenced by the container reference. The sharing handler may perform post-processing on the container reference to update the paths for the item references. The paths may be changed from local to remote for items that are shared or from remote to local for items that are unshared.

### BACKGROUND

Sharing is the joint use of a resource or space. The issue of handling shared resources figures prominently in computer science. In computing, a shared resource is a device or piece of information on a computer that can be remotely accessed from another computer, typically via a local area network or an enterprise intranet, as if it were a resource in the local machine. The share can be accessed by client computers through some naming convention, such as UNC (universal naming convention) used on some computers.

Computer environments often contain items such as files and folders, and items such as libraries and shortcuts that reference other items. Modern operating systems for personal computers (PCs) include distributed file systems that support file sharing. An example is a shared file access (also known as disk sharing and folder sharing). Existing sharing models act directly on items selected, such as files or folders, and do not handle items that reference other items, such as libraries and shortcuts. The user is required to operate on each item references by a library or shortcut separately and share them out to other computing devices, computing applications, or users. This can be tedious and time consuming.

### SUMMARY

A container reference may reference other items and may be shared or unshared among computing devices, computing applications, or users, thereby providing or restricting access to the container reference and its associated items. A sharing handler may be registered for the container reference and may be used in conjunction with the sharing and unsharing of the container reference and the items that are referenced by the container reference.

In an implementation, a sharing handler may perform post-processing on a container reference to update the paths for item references in the container reference. The paths may be changed from local to remote for items that are shared or from remote to local for items that are unshared.

In an implementation, a container reference that may be shared or unshared may comprise a library of item locations. Items corresponding to the item locations may comprise files or folders.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 shows an example of a computing environment in which aspects and embodiments may be potentially exploited;

FIG. 2 is an operational flow of an implementation of a method of setting access to an item in a computing environment.

FIG. 3 is an operational flow of an implementation of a method of sharing an item in a computing environment;

FIG. 4 is an operational flow of an implementation of a method of unsharing an item in a computing environment; and

FIG. 5 shows an exemplary computing environment.

### DETAILED DESCRIPTION

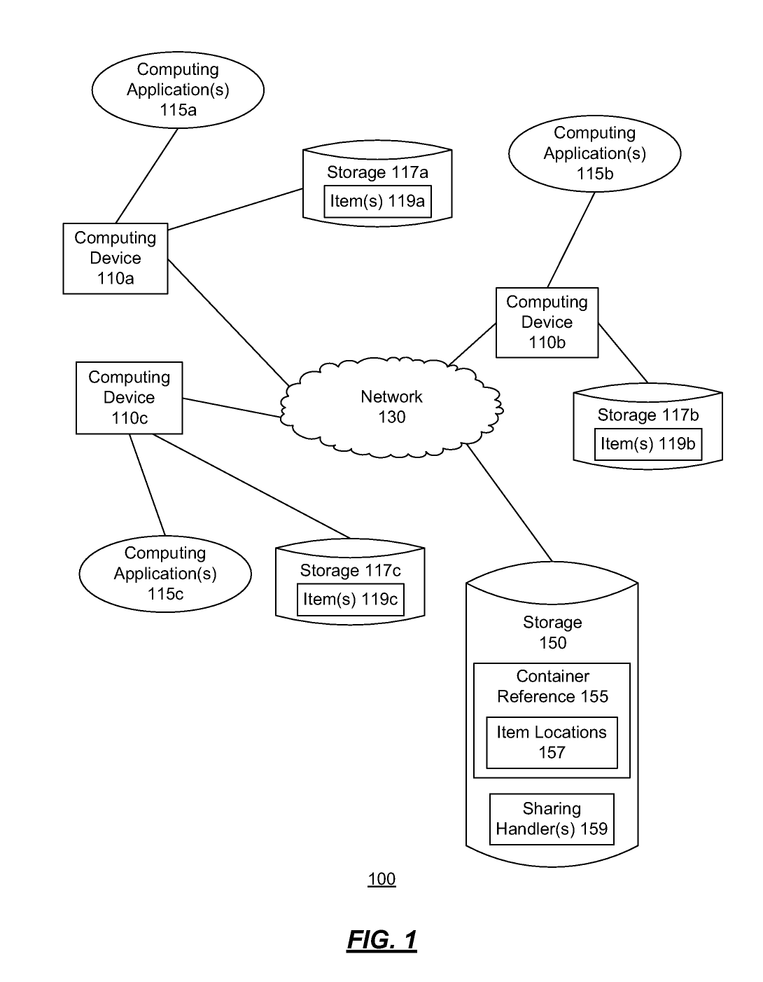

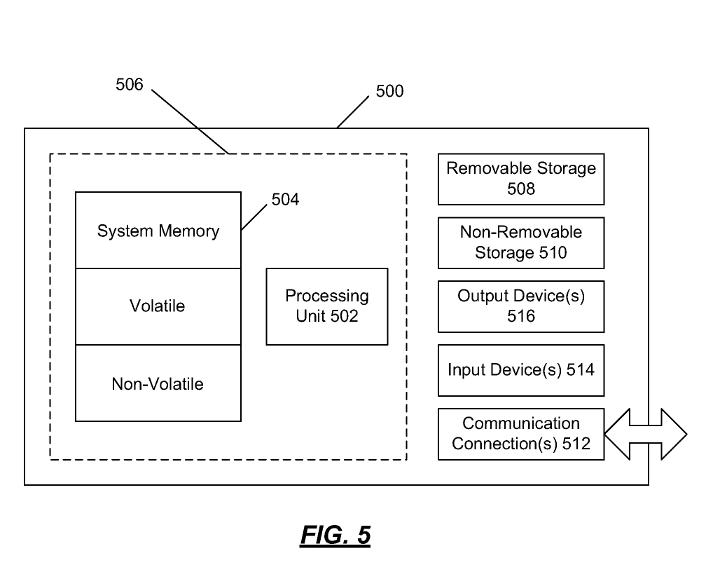

FIG. 1 shows an example of a computing environment 100 in which aspects and embodiments may be potentially exploited. The environment 100 includes one or more computing devices 110 (denoted as computing devices 110a-110c) connected to each other by a network 130, for example, the Internet, a wide area network (WAN) or local area network (LAN). Although only three computing devices 110a-110c are shown in FIG. 1, it is contemplated that any number of computing devices may be implemented in the computing environment 100. An example computing device and its components are described in more detail with respect to FIG. 5.

Each computing device 110 may be equipped with one or more computing applications 115 (denoted as computing application(s) 110a-110c) that may be used in the performance of the techniques and operations described herein. Examples of computing applications may include applications for receiving a request to share or unshare an item such as a container reference 155 (e.g., a library, a search based query, a list of favorites, etc. that may span items across multiple locations), sharing or unsharing the container reference 155, and performing post-processing, described further herein.

Each computing device 110 also may comprise connections or access to various types of storage 117 (denoted as storage 117a-117c) and 150. The storage 117 may be internal to or external from the computing device 110, and may store one or more items 119 (denoted as items 119a-119c) such as files or folders as well as items that reference other items. The location of each item 119 in storage 117 may have a path that may be entered into a computing application 115 on the computing device 110 to access the item. The path may be indicative of the item location in storage 117.

Storage 150 may comprise any type of storage device or data source and may be accessible to the computing devices 110 via the network 130. Storage 150 may store the container reference 155 which may comprise item locations 157. One or more sharing handlers 159 may also be stored in storage such as storage 150. The container reference 155 may be shared among computing applications 115, computing devices 110, or users such that the item locations 157 spanned by the container reference 155 are shared among the computing applications 115, computing devices 110, or users. In this manner, the computing applications 115, computing devices 110, or users may be provided with access to the container reference 155 and its item locations 157. Storage 150 may be associated with any computing device, such as one or more of the computing devices 110 or other computing devices (not shown). It is contemplated that storage 150 may be comprised within the storage 117 associated with one or more of the computing devices 110.

The container reference 155 is an item that stores pointers or references to other items. Container references may be shared and unshared. A library is a type of container reference. Libraries may allow a user of a computing device to collectively view and access content from multiple locations local to or remote from their computing device, such as via local file system paths, network paths, RSS feeds, etc.

The container reference 155 may point to local paths, directed to item locations 157, of one computing device which are not accessible by another computing device (e.g., a remote computing device) or another computing application. However, the container reference 155 may be shared, so that one or more of the item locations 157 may be shared and accessible by another computing device or another computing application. Once the item locations 157 are indicated or otherwise marked to be shared, the paths corresponding to the item locations 157 may be modified from a local path format to a remote location path format. The remote location path may be provided in a universal naming convention (UNC) format. UNC specifies a common syntax to describe the location of a network resource, such as a shared file, directory, or printer, and may specify a remote location path, such as a network path, that is accessible from another computing device or another computing application instead of a local path. It is contemplated that any remote location path format may be used with the techniques described herein.

Similarly, a container reference 155 such as a library, or one or more item locations 157 that the container reference 155 spans, may be unshared. Thus, the computing applications 115, computing devices 110, or users may be denied or otherwise provided with restricted access to the container reference 155 and its item locations 157. Accordingly, remote location paths may be changed to local paths.

Thus, a user may share or unshare multiple locations that a container reference spans by operating on the container reference itself. As a result, the user may take one single operation for sharing or unsharing multiple locations and not have to individually go share out (or unshare) each location the container reference spans.

A handler is software code that reacts to an event or specializes in a type of data. Each of the sharing handlers 159 may comprise an application that may provide locations for an item and may be registered for a particular item type, such as a library or other container reference. Each of the sharing handlers 159 may be registered for a different item type, and thus different types of items may have locations that may be shared and unshared.

Although a library is used herein as an example of an entity that can span multiple locations, it is contemplated that any entity that is a collection of items like a search based query, list of favorites, etc. may span items across multiple locations and may be shared and unshared as described herein. The items that belong to the collection of the entity may be shared or unshared when operating on the entity.

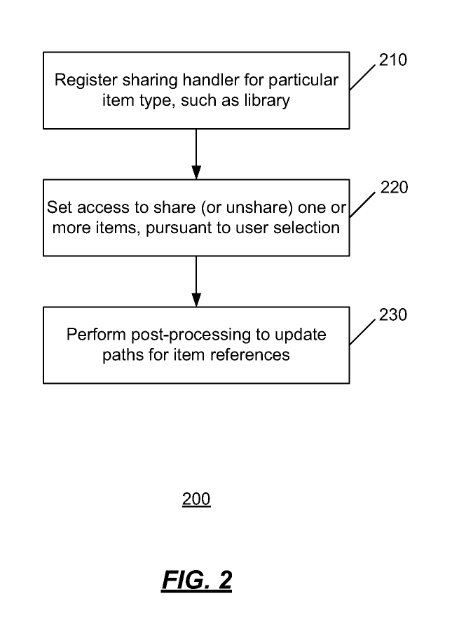

FIG. 2 is an operational flow of an implementation of a method 200 of setting access to an item in a computing environment. The user may select a single entity that spans multiple locations, such as a library, as an item to share or unshare.

At 210, a sharing handler may be registered for a particular item type, such as a library. The sharing handler may be registered by a user in the registry of a computing device. A registry is a directory which stores settings and options for the operating system of a computing device. The registry may contain information and settings for the hardware, operating system software, non-operating system software, users, preferences of the computing device, etc.

By registering a sharing handler for an item type such as a library, item locations contained within the library along with the items themselves may be shared among multiple computing devices, multiple computing applications, or users using a call to the sharing handler. Items and item locations may also be unshared by the sharing handler such that items and item locations that were previously shared may be made private and no longer subject to sharing.

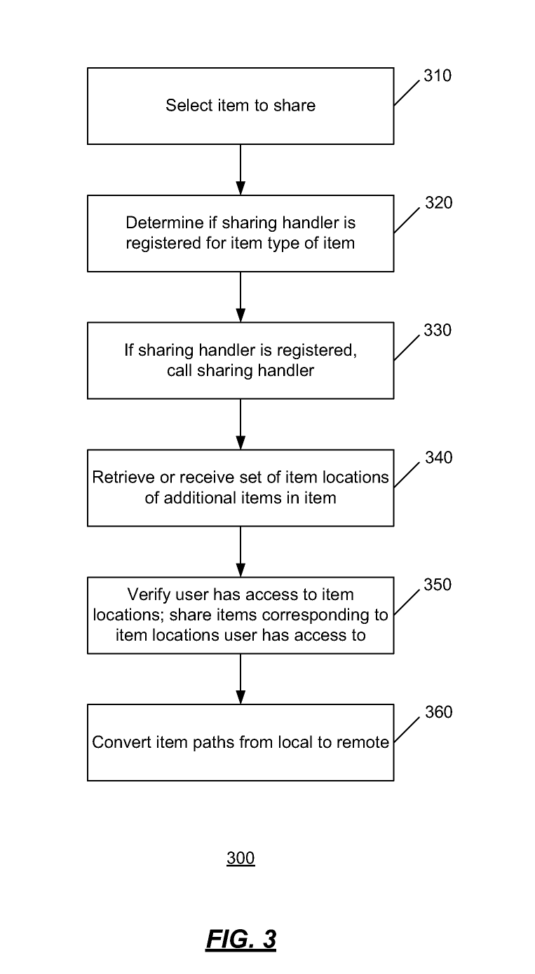

At 220, access to one or more items may be set. In an implementation, one or more items may be shared, as described further with respect to the method 300 of FIG. 3. The items may be shared pursuant to a user selection of an item that spans multiple locations such as a library. The locations that are part of the library, or within the scope of the library, may be determined and shared. The items corresponding to the locations may be shared with one or more computing devices, computing applications, or users. Alternatively, one or more items may be unshared.

At 230, post-processing may be performed to update the paths for the item references (corresponding to the item locations) in the library. The paths may be changed from local to remote for items that are shared or from remote to local for items that are unshared.

For example, suppose “Container A” has references to two local locations for items “folder1” and “folder2” as follows:

Location 1=c:\users\me\folder1

Location 2=c:\users\me\folder2.

If the items are shared, post-processing may convert or otherwise change the local locations to remote locations as follows:

Location 1=\\computer\share\users\me\folder1

Location 2=\\computer\share\users\me\folder2.

If the items are unshared (after being shared), post-processing may convert or otherwise change the remote locations to local locations as follows:

Location 1=c:\users\me\folder1

Location 2=c:\users\me\folder2.

FIG. 3 is an operational flow of an implementation of a method 300 of sharing an item in a computing environment. At 310, a user may select an item to share that the user has access to. The item may be any type of file, folder, library or other container reference, etc. and selections may be made via a computing application and/or a computing device. It may be determined at 320 if a sharing handler is registered for the item type of that item. Assuming there is a sharing handler registered for the item type, the sharing handler may be called at 330.

At 340, the sharing handler may retrieve or receive a set of item locations of additional items from the library (e.g., item locations that are part of the library and/or within the scope of the library). The locations may include local file system locations, network locations, web locations, etc. At 350, the sharing handler may verify that the user has access to the locations that are to be shared (i.e., has authorization or permission to share the items corresponding to the locations). The sharing handler may share the additional items (that the user has authorization or permission to share) with one or more computing devices, computing applications, or users as specified by the user.

After the sharing is completed, post-processing may be performed at 360 to update the item references in the library from a local path to a remote path. In an implementation, the sharing handler may update the references to the locations from local paths to UNC paths. Thus, the handler may update the library content after sharing is performed to convert item paths from local to UNC so that they are accessible remotely.

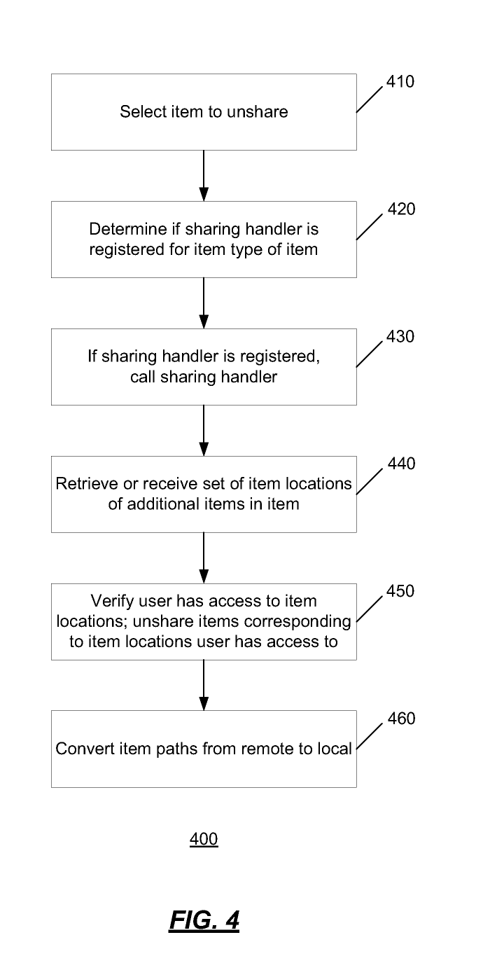

FIG. 4 is an operational flow of an implementation of a method 400 of unsharing an item in a computing environment. At 410, a user may select an item to unshare that the user has access to and that is previously being shared with one or more computing devices, computing applications, or users. Similar to 320 and 330, respectively, it may be determined at 420 if a sharing handler is registered for the item type of that item, and if so, the sharing handler may be called 430.

At 440, the sharing handler may retrieve or receive a set of item locations of additional items from the library corresponding to items that may be unshared. At 450, the sharing handler may verify that the user has access to the locations that are to be unshared and unshares the accessible additional items with one or more computing devices, computing applications, or users as specified by the user.

Post-processing may be performed at 460 to update the item references of the unshared items in the library from remote paths to local paths. In an implementation, the sharing handler may update the reference to the locations that are being unshared from a UNC path to a local path.

It is noted that the sharing handler is not limited to item types that span additional locations. In an implementation, the sharing handler may be used as an event notification mechanism where a request to retrieve items would return nothing and some item specific work would be performed in post-processing. Additionally the sharing handler may be used to block sharing. For example, a video file handler may be registered to check for copyright information, and if a file is copyrighted, then sharing may be prevented.

FIG. 5 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, PCs, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by device 500 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of setting access in a computing environment, comprising:
receiving a selection of an item to set access for the item;
setting access for the item and a plurality of additional items referenced by the item; and
updating a plurality of paths associated with locations of the additional items.

2. The method of claim 1, further comprising registering a sharing handler for a type of the item, and determining if the sharing handler is registered for the type of the item prior to setting access for the item and the additional items referenced by the item, the sharing handler used to set access for the item and the additional items and update the paths associated with the locations of the additional items.

3. The method of claim 1, wherein setting access comprises sharing the item and the additional items with at least one computing device, computing application, or user.

4. The method of claim 3, wherein updating the paths associated with the locations of the additional items comprises changing each path from a local path to a remote path.

5. The method of claim 1, wherein setting access comprises unsharing the item and the additional items with at least one computing device, computing application, or user.

6. The method of claim 5, wherein updating the paths associated with the locations of the additional items comprises changing each path from a remote path to a local path.

7. The method of claim 1, wherein the item is a container reference.

8. The method of claim 7, wherein the container reference comprises a library.

9. A method of sharing an item in a computing environment, comprising:
calling a sharing handler for an item;
receiving a plurality of item locations using the sharing handler, each item location associated with an additional item referenced by the item;
sharing the additional items with at least one computing device, computing application, or user; and
converting a plurality of items paths of the additional items from local to remote.

10. The method of claim 9, wherein the item comprises a container reference.

11. The method of claim 9, wherein the item is an entity that spans the plurality of item locations.

12. The method of claim 9, further comprising determining if the sharing handler is registered for a type corresponding to the item, and if so, then calling the sharing handler for the item.

13. The method of claim 12, wherein receiving the item locations and sharing the additional items is performed if the sharing handler is registered for the item.

14. The method of claim 9, further comprising receiving a selection of the item from a user prior to calling the sharing handler.

15. The method of claim 14, further comprising verifying that the user has access to the item locations and if so, then sharing the additional items.

16. A sharing handler comprising:
at least one subsystem that receives a call pursuant to a selection from a user of an item for which access is to be set;
at least one subsystem that receives a plurality of item locations, each item location associated with an additional item referenced by the item;
at least one subsystem that sets access for the additional items for at least one computing device, computing application, or user; and
at least one subsystem that updates a plurality of paths associated with the item locations of the additional items.

17. The sharing handler of claim 16, further comprising at least one subsystem that verifies that the user has access to the item locations.

18. The sharing handler of claim 16, wherein the at least one subsystem that sets access shares the item and the additional items with the at least one computing device, computing application, or user, and wherein the at least one subsystem that updates the paths associated with the item locations of the additional items changes each path from a local path to a remote path.

19. The sharing handler of claim 16, wherein the at least one subsystem that sets access unshares the item and the additional items with the at least one computing device, computing application, or user, and wherein the at least one subsystem that updates the paths associated with the item locations of the additional items changes each path from a remote path to a local path.

20. The sharing handler of claim 16, wherein the item comprises a container reference that spans the plurality of item locations.
